(19) United States
(12) Patent Application Publication
(10) Pub. No.: US 2009/0320081 A1
(43) Pub. Date: Dec. 24, 2009

(54) Providing and Displaying Video at Multiple Resolution and Quality Levels

(76) Inventors: Charles K. Chui, Menlo Park, CA (US); Haishan Wang, San Carlos, CA (US); Dongfang Shi, Mountain View, CA (US)

Correspondence Address: MORGAN, LEWIS & BOCKIUS, LLP. (PA), 2 PALO ALTO SQUARE, 3000 EL CAMINO REAL, SUITE 700, PALO ALTO, CA, 94306, US

(21) Appl. No.: 12/173,768

(22) Filed: Jul. 15, 2008

Related U.S. Application Data
(60) Provisional application No. 61/075,305, filed on Jun. 24, 2008.

(51) Int. Cl. H04N 7/173; H04B 1/66

(52) U.S. Cl. 725/93; 375/240.01; 375/E07.001

(57) ABSTRACT

A method provides video from a video data source comprising a sequence of multi-level frames. Each multi-level frame comprises multiple copies of a respective frame. Each copy has an associated video resolution or quality level that is a member of a predefined range of levels that range from a highest level to a lowest level. First video data corresponding to a first portion of a first copy of a respective frame and second video data corresponding to a second portion of a second copy of the respective frame are extracted from the video data source. The video resolution or quality level of the second copy is distinct from that of the first copy. The first and second video data are transmitted to a client device for display. The extracting and transmitting are repeated with respect to successive multi-level frames of the video data source.

### RELATED APPLICATIONS

This application claims priority to U.S. Provisional Patent Application No. 61/075,305, titled “Providing and Displaying Video at Multiple Resolution and Quality Levels,” filed Jun. 24, 2008, which is hereby incorporated by reference in its entirety.

This application is related to U.S. patent application Ser. No. 11/639,780, titled “Encoding Video at Multiple Resolution Levels,” filed Dec. 15, 2006, and to U.S. patent application Ser. No. 12/145,453, titled “Displaying Video at Multiple Resolution Levels,” filed Jun. 24, 2008, both of which are hereby incorporated by reference in their entireties.

### TECHNICAL FIELD

The disclosed embodiments relate generally to providing and displaying video, and more particularly, to methods and systems for providing and displaying video at multiple distinct video resolution or quality levels.

### BACKGROUND

Many modern devices for displaying video, such as high-definition televisions, computer monitors, and cellular telephone display screens, allow users to manipulate the displayed video by zooming. In traditional systems for zooming video, the displayed resolution of the video does not increase as the zoom factor increases, causing the zoomed video to appear blurry and resulting in an unpleasant viewing experience. Furthermore, users also may desire to zoom in on only a portion of the displayed video and to view the remainder of the displayed video at a lower resolution.

In addition, bandwidth limitations may constrain the ability to provide high resolution and high quality video. A user frustrated by low-quality video may desire to view at least a portion of the video at higher quality.

### SUMMARY

In some embodiments a method is performed to provide video from a video data source. The video data source includes a sequence of multi-level frames. Each multi-level frame comprises a plurality of copies of a respective frame. In one aspect, each copy has an associated video resolution level that is a member of a predefined range of video resolution levels that range from a highest video resolution level to a lowest video resolution level. In another aspect, each copy has an associated video quality level that is a member of a predefined range of video quality levels that range from a highest video quality level to a lowest video quality level. In the method, first video data corresponding to a first portion of a first copy of a respective frame is extracted from the video data source. In addition, second video data corresponding to a second portion of a second copy of the respective frame is extracted from the video data source. The video resolution level or video quality level of the second copy is distinct from the video resolution level or video quality level of the first copy. The first and second video data are transmitted to a client device for display. The extracting and transmitting are repeated with respect to a plurality of successive multi-level frames of the video data source.

In some embodiments a system provides video from a video data source. The video data source includes a sequence of multi-level frames. Each multi-level frame includes a plurality of copies of a respective frame. In one aspect, each copy has an associated video resolution level that is a member of a predefined range of video resolution levels that range from a highest video resolution level to a lowest video resolution level. In another aspect, each copy has an associated video quality level that is a member of a predefined range of video quality levels that range from a highest video quality level to a lowest video quality level. The system includes memory, one or more processors, and one or more programs stored in the memory and configured for execution by the one or more processors. The one or more programs include instructions to extract, from the video data source, first video data corresponding to a first portion of a first copy of a respective frame and instructions to extract, from the video data source, second video data corresponding to a second portion of a second copy of the respective frame. The video resolution level or video quality level of the second copy is distinct from the video resolution level or video quality level of the first copy. The one or more programs further include instructions to transmit the first and second video data to a client device for display and instructions to repeat the extracting and transmitting with respect to a plurality of successive multi-level frames of the video data source.

In some embodiments a computer readable storage medium stores one or more programs for use in providing video from a video data source. The video data source includes a sequence of multi-level frames. Each multi-level frame includes a plurality of copies of a respective frame. In one aspect, each copy has an associated video resolution level that is a member of a predefined range of video resolution levels that range from a highest video resolution level to a lowest video resolution level. In another aspect, each copy has an associated video quality level that is a member of a predefined range of video quality levels that range from a highest video quality level to a lowest video quality level. The one or more programs are configured to be executed by a computer system and include instructions to extract, from the video data source, first video data corresponding to a first portion of a first copy of a respective frame and instructions to extract, from the video data source, second video data corresponding to a second portion of a second copy of the respective frame. The video resolution level or video quality level of the second copy is distinct from the video resolution level or video quality level of the first copy. The one or more programs also include instructions to transmit the first and second video data to a client device for display and instructions to repeat the extracting and transmitting with respect to a plurality of successive multi-level frames of the video data source.

In some embodiments a system provides video from a video data source. The video data source includes a sequence of multi-level frames. Each multi-level frame includes a plurality of copies of a respective frame. In one aspect, each copy has an associated video resolution level that is a member of a predefined range of video resolution levels that range from a highest video resolution level to a lowest video resolution level. In another aspect, each copy has an associated video quality level that is a member of a predefined range of video quality levels that range from a highest video quality level to a lowest video quality level. The system includes means for extracting, from the video data source, first video data corresponding to a first portion of a first copy of a respective frame and means for extracting, from the video data source, second video data corresponding to a second portion of a second copy of the respective frame. The video resolution level or video quality level of the second copy is distinct from the video resolution level or video quality level of the first copy. The system also includes means for transmitting the first and second video data to a client device for display. The means for extracting and means for repeating are configured to repeat the extracting and transmitting with respect to a plurality of successive multi-level frames of the video data source.

In some embodiments a method of displaying video at a client device separate from a server includes transmitting to the server a request specifying a window region to display over a background region in a video. First and second video data are received from the server. The first video data corresponds to a first portion of a first copy of a first frame in a sequence of frames. The second video data corresponds to a second portion of a second copy of the first frame. In one aspect the first copy and the second copy have distinct video resolution levels; in another aspect the first copy and the second copy have distinct video quality levels. The first and second video data are decoded. The decoded first video data are displayed in the background region and the decoded second video data are displayed in the window region. The receiving, decoding, and displaying are repeated with respect to a plurality of successive frames in the sequence.

In some embodiments a client device separate from a server displays video. The client device includes memory, one or more processors, and one or more programs stored in the memory and configured for execution by the one or more processors. The one or more programs include instructions to transmit to the server a request specifying a window region to display over a background region in a video and instructions to receive first and second video data from the server. The first video data corresponds to a first portion of a first copy of a first frame in a sequence of frames and the second video data corresponds to a second portion of a second copy of the first frame, wherein the first copy and the second copy have distinct video resolution levels or video quality levels. The one or more programs also include instructions to decode the first and second video data; instructions to display the decoded first video data in the background region and the decoded second video data in the window region; and instructions to repeat the receiving, decoding, and displaying with respect to a plurality of successive frames in the sequence.

In some embodiments a computer readable storage medium stores one or more programs for use in displaying video at a client device separate from a server. The one or more programs are configured to be executed by a computer system and include instructions to transmit to the server a request specifying a window region to display over a background region in a video and instructions to receive first and second video data from the server. The first video data corresponds to a first portion of a first copy of a first frame in a sequence of frames and the second video data corresponds to a second portion of a second copy of the first frame. The first copy and the second copy have distinct video resolution levels or video quality levels. The one or more programs also include instructions to decode the first and second video data; instructions to display the decoded first video data in the background region and the decoded second video data in the window region; and instructions to repeat the receiving, decoding, and displaying with respect to a plurality of successive frames in the sequence.

In some embodiments a client device separate from a server is used for displaying video. The client device includes means for transmitting to the server a request specifying a window region to display over a background region in a video and means for receiving first and second video data from the server. The first video data corresponds to a first portion of a first copy of a first frame in a sequence of frames and the second video data corresponds to a second portion of a second copy of the first frame. The first copy and the second copy have distinct video resolution levels or video quality levels. The client device also includes means for decoding the first and second video data and means for displaying the decoded first video data in the background region and the decoded second video data in the window region. The means for receiving, decoding, and displaying are configured to repeat the receiving, decoding, and displaying with respect to a plurality of successive frames in the sequence.

### BRIEF DESCRIPTION OF THE DRAWINGS

FIG. 1 is a block diagram illustrating a video delivery system in accordance with some embodiments.

FIG. 2 is a block diagram illustrating a client device in accordance with some embodiments.

FIG. 3 is a block diagram illustrating a server system in accordance with some embodiments.

FIG. 4 is a block diagram illustrating a sequence of multi-level video frames in accordance with some embodiments.

FIGS. 5A and 5B are prophetic, schematic diagrams of video frames and the user interface of a client device, illustrating display of a first region of video at a first video resolution level and a second region of video at a second video resolution level in accordance with some embodiments.

FIG. 5C is a prophetic, schematic diagram of video frames and the user interface of a client device, illustrating display of a first region of video at a first video quality level and a second region of video at a second video quality level in accordance with some embodiments.

FIG. 6 is a flow diagram illustrating a method of identifying a portion of a frame for display in a window region of a display screen in accordance with some embodiments.

FIG. 7 is a prophetic, schematic diagram of a video frame partitioned into tiles and macro-blocks in accordance with some embodiments.

FIG. 8 is a flow diagram illustrating a method of extracting bitstreams from frames in accordance with some embodiments.

FIGS. 9A-9F are prophetic, schematic diagrams of video frames and the user interface of a client device, illustrating translation of a window region on a display screen in accordance with some embodiments.

FIG. 9G is a block diagram illustrating two frames in a sequence of frames in accordance with some embodiments.

FIG. 9H is a flow diagram illustrating a method of implementing automatic translation of a window region in accordance with some embodiments.

FIG. 10 is a flow diagram illustrating a method of providing video in accordance with some embodiments.

FIGS. 11A-11C are flow diagrams illustrating a method of displaying video at a client device separate from a server in accordance with some embodiments.

Like reference numerals refer to corresponding parts throughout the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the embodiments.

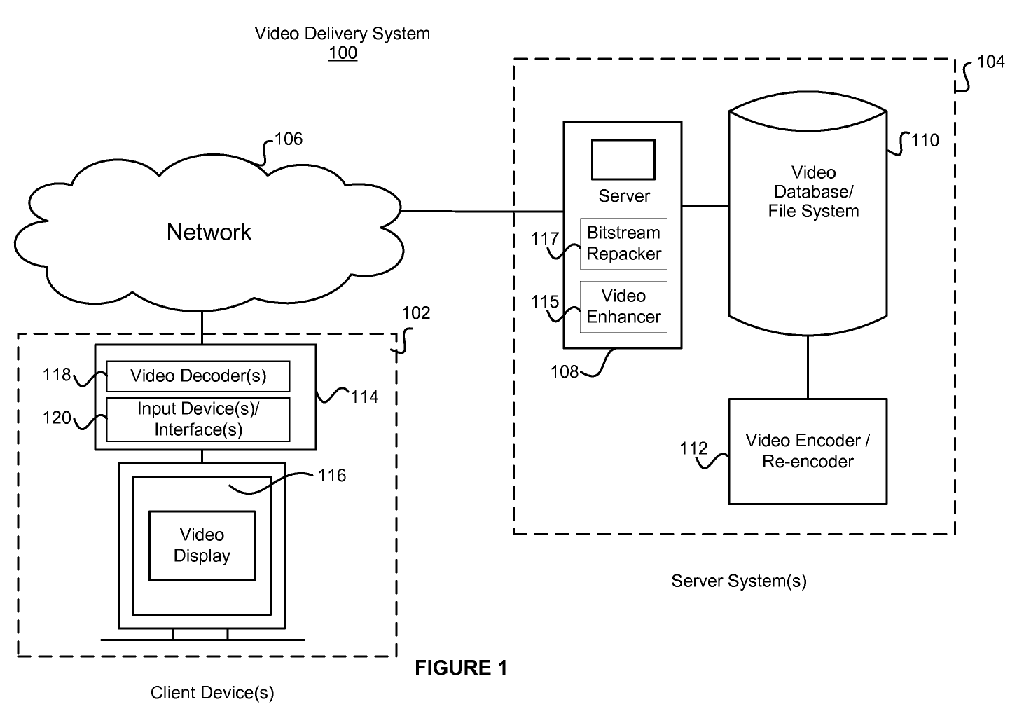

FIG. 1 is a block diagram illustrating a video delivery system in accordance with some embodiments. The video delivery system 100 includes a server system 104 coupled to one or more client devices 102 by a network 106. The network 106 may be any suitable wired and/or wireless network and may include a cellular telephone network, a cable television network, satellite transmission, telephone lines, a local area network (LAN), a wide area network (WAN), the Internet, a metropolitan area network (MAN), WIFI, WIMAX, or any combination of such networks.

The server system 104 includes a server 108, a video database or file system 110 and a video encoder/re-encoder 112. Server 108 serves as a front-end for the server system 104. Server 108, sometimes called a front end server, retrieves video from the video database or file system 110, and also provides an interface between the server system 104 and the client devices 102. In some embodiments, server 108 includes a bitstream repacker 117 and a video enhancer 115. In some embodiments, the bitstream repacker 117 repacks at least a portion of one or more bitstreams comprising video data with multiple levels of resolution or multiple quality levels to a standard bitstream. In some embodiments, the video enhancer 115 eliminates artifacts associated with encoding and otherwise improves video quality. The bitstream repacker 117 and video enhancer 115 may each be implemented in hardware or in software.

In some embodiments, the video encoder/re-encoder 112 re-encodes video data received from the video database or file system 110. In some embodiments, the video data provided to the encoder/re-encoder 112 is stored in the video database or file system 110 in one or more standard video formats, such as motion JPEG (M-JPEG), MPEG-2, MPEG-4, H.263, H.264/Advanced Video Coding (AVC), or any other official or defacto standard video format. The re-encoded video data produced by the encoder/re-encoder 112 may be stored in the video database or file system 110 as well. In some embodiments, the re-encoded video data include a sequence of multi-level frames; in some embodiments the multi-level frames are partitioned into tiles. In some embodiments, a respective multi-level frame in the sequence includes a plurality of copies of a frame, each having a distinct video resolution level. Generation of multi-level frames that have multiple distinct video resolution levels and partitioning of multi-level frames into tiles is described in the “Encoding Video at Multiple Resolution Levels” application (see Related Applications, above). In some embodiments, respective multi-level frames in the sequence comprise a plurality of copies of a frame, wherein each copy has the same video resolution level but a distinct video quality level, such as distinct level of quantization or truncation of the corresponding video bitstream.

In some embodiments, the video encoder/re-encoder 112 encodes video data received from a video camera such as a camcorder (not shown). In some embodiments, the video data received from the video camera is raw video data, such as pixel data. In some embodiments, the video encoder/re-encoder 112 is separate from the server system 104 and transmits encoded or re-encoded video data to the server system 104 via a network connection (not shown) for storage in the video database or file system 110.

In some embodiments, the functions of server 108 may be divided or allocated among two or more servers. In some embodiments, the server system 104, including the server 108, the video database or file system 110, and the video encoder/re-encoder 112 may be implemented as a distributed system of multiple computers and/or video processors. However, for convenience of explanation, the server system 104 is described below as being implemented on a single computer, which can be considered a single logical system.

A user interfaces with the server system 104 and views video at a client system or device 102 (called the client device herein for ease of reference). The client device 102 includes a computer 114 or computer-controlled device, such as a set-top box (STB), cellular telephone, smart phone, person digital assistant (PDA), or the like. The computer 114 typically includes one or more processors (not shown); memory, which may include volatile memory (not shown) and non-volatile memory such as a hard disk drive (not shown); one or more video decoders 118; and a display 116. The video decoders 118 may be implemented in hardware or in software. In some embodiments, the computer-controlled device 114 and display 116 are separate devices (e.g., a set-top box or computer connected to a separate monitor or television or the like), while in other embodiments they are integrated into a single device. For example, the computer-controlled device 114 may be a portable electronic device that includes a display screen, such as a cellular telephone, personal digital assistant (PDA), or portable music and video player. In another example, the computer-controlled device 114 is integrated into a television. The computer-controlled device 114 includes one or more input devices or interfaces 120. Examples of input devices 120 include a keypad, touchpad, touch screen, remote control, keyboard, or mouse. In some embodiments, a user may interact with the client device 102 via an input device or interface 120 to display a first region of video at a first video resolution level or quality level and a second region of video at a second video resolution level or quality level on the display 116.

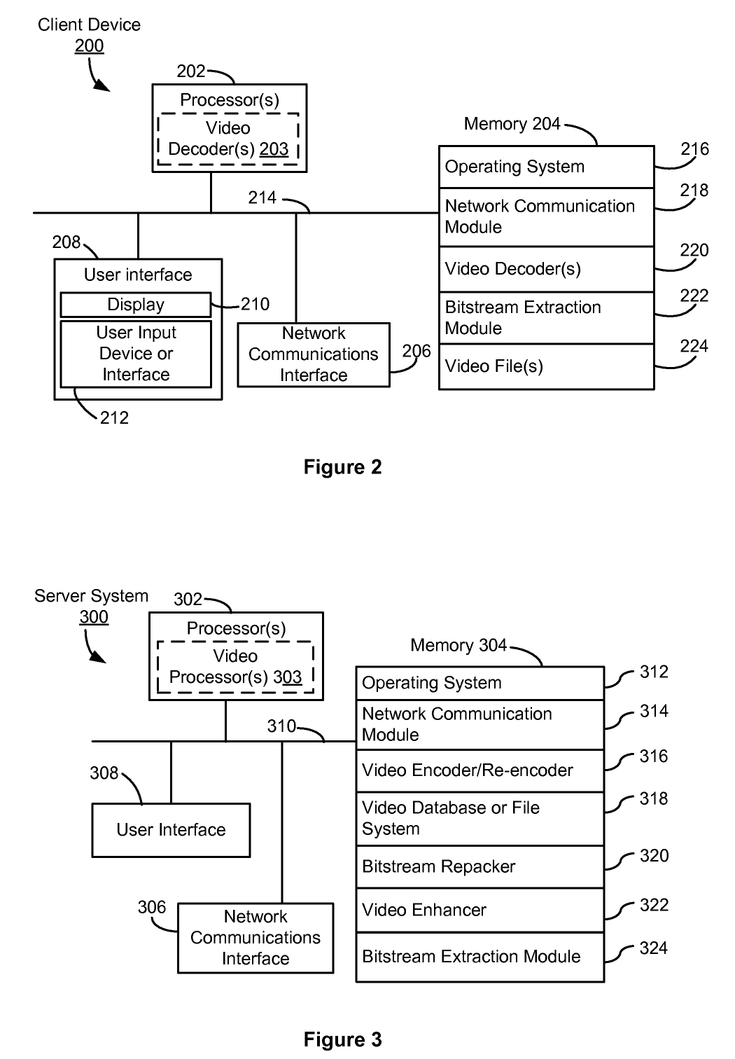

FIG. 2 is a block diagram illustrating a client device 200 in accordance with some embodiments. The client device 200 typically includes one or more processors 202, one or more network or other communications interfaces 206, memory 204, and one or more communication buses 214 for interconnecting these components. In some embodiments, the one or more processors 202 include one or more video decoders 203 implemented in hardware. The one or more network or other communications interfaces 206 allow transmission and reception of data (e.g., transmission of requests to a server and reception of video data from the server) through a network connection and may include a port for establishing a wired network connection and/or an antenna for establishing a wireless network connection, along with associated transmitter and receiver circuitry. The communication buses 214 may include circuitry (sometimes called a chipset) that interconnects and controls communications between system components. The client device 200 may also include a user interface 208 that includes a display device 210 and a user input device or interface 212. In some embodiments, the user input device or interface 212 includes a keypad, touchpad, touch screen, remote control, keyboard, or mouse. Alternately, the user input device or interface 212 receives user instructions or data from one or more such user input devices. Memory 204 includes high-speed random access memory, such as DRAM, SRAM, DDR RAM or other random access solid-state memory devices, and may include non-volatile memory, such as one or more magnetic disk storage devices, optical disk storage devices, flash memory devices, or other non-volatile solid-state storage devices. Memory 204 may optionally include one or more storage devices remotely located from the processor(s) 202. Memory 204, or alternately the non-volatile memory device(s) within memory 204, comprises a computer readable storage medium. In some embodiments, memory 204 stores the following programs, modules, and data structures, or a subset thereof:
an operating system 216 that includes procedures for handling various basic system services and for performing hardware-dependent tasks;
a network communication module 218 that is used for connecting the client device 200 to other computers via the one or more communication network interfaces 206 and one or more communication networks, such as the Internet, other wide area networks, local area networks, metropolitan area networks, and the like;
one or more video decoder modules 220 for decoding received video;
a bitstream extraction module 222 for identifying portions of video frames and extracting corresponding bitstreams; and
one or more video files 224;
   In some embodiments, received video may be cached locally in memory 204.

Each of the above identified elements 216-224 in FIG. 2 may be stored in one or more of the previously mentioned memory devices. Each of the above identified modules corresponds to a set of instructions for performing a function described above. The above identified modules or programs (i.e., sets of instructions) need not be implemented as separate software programs, procedures, or modules, and thus various subsets of these modules (or sets of instructions) may be combined or otherwise re-arranged in various embodiments. In some embodiments, memory 204 may store a subset of the modules and data structures identified above. Furthermore, memory 204 may store additional modules and data structures not described above.

FIG. 3 is a block diagram illustrating a server system 300 in accordance with some embodiments. The server system 300 typically includes one or more processors 302, one or more network or other communications interfaces 306, memory 304, and one or more communication buses 310 for interconnecting these components. The processor(s) 302 may include one or more video processors 303. The one or more network or other communications interfaces 306 allow transmission and reception of data (e.g., transmission of video data to a client and reception of requests from the client) through a network connection and may include a port for establishing a wired network connection and/or an antenna for establishing a wireless network connection, along with associated transmitter and receiver circuitry. The communication buses 310 may include circuitry (sometimes called a chipset) that interconnects and controls communications between system components. The server system 300 optionally may include a user interface 308, which may include a display device (not shown), and a keyboard and/or a mouse (not shown). Memory 304 includes high-speed random access memory, such as DRAM, SRAM, DDR RAM or other random access solid-state memory devices; and may include non-volatile memory, such as one or more magnetic disk storage devices, optical disk storage devices, flash memory devices, or other non-volatile solid state storage devices. Memory 304 may optionally include one or more storage devices remotely located from the processor(s) 302. Memory 304, or alternately the non-volatile memory device(s) within memory 304, comprises a computer readable storage medium. In some embodiments, memory 304 stores the following programs, modules, and data structures, or a subset thereof:
an operating system 312 that includes procedures for handling various basic system services and for performing hardware dependent tasks;
a network communication module 314 that is used for connecting the server system 300 to other computers via the one or more communication network interfaces 306 and one or more communication networks, such as the Internet, other wide area networks, local area networks, metropolitan area networks, cellular telephone networks, cable television networks, satellite, and so on;
a video encoder/re-encoder module 316 for encoding video in preparation for transmission via the one or more communication network interfaces 306;
a video database or file system 318 for storing video;
a bitstream repacking module 320 for repacking at least a portion of a bitstream comprising video data with multiple levels of resolution or multiple quality levels to a standard bitstream;
a video enhancer module 322 for eliminating artifacts associated with encoding and otherwise improving video quality; and
a bitstream extraction module 222 for identifying portions of video frames and extracting corresponding bitstreams.

Each of the above identified elements in FIG. 3 may be stored in one or more of the previously mentioned memory devices. Each of the above identified modules corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 304 may store a subset of the modules and data structures identified above. Furthermore, memory 304 may store additional modules and data structures not described above.

Although FIG. 3 shows a “server system,” FIG. 3 is intended more as a functional description of the various features which may be present in a set of servers than as a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers and/or video processors.

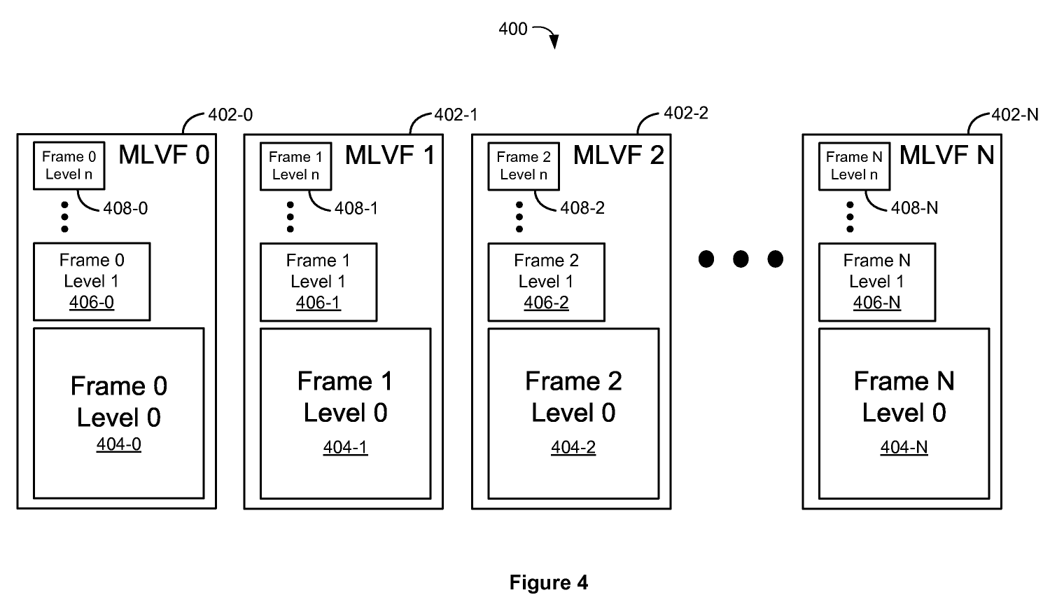

FIG. 4 is a block diagram illustrating a sequence 400 of multi-level video frames (MLVFs) 402 in accordance with some embodiments. In some embodiments, the sequence 400 is stored in the video database 318 of a server system 300 (FIG. 3). Alternatively, in some embodiments the sequence 400 is stored in a video file 224 in memory 204 of a client device 200. The sequence 400 includes MLVFs 402-0 through 402-N. Each MLVF 402 comprises n+1 copies of a frame, labeled level 0 (404) through level n (408). In some embodiments, each copy has an associated video resolution level that is a member of a predefined range of video resolution levels that range from a highest video resolution level to a lowest video resolution level. In some embodiments, each copy has an associated video quality level that is a member of a predefined range of video quality levels that range from a highest video quality level to a lowest video quality level.

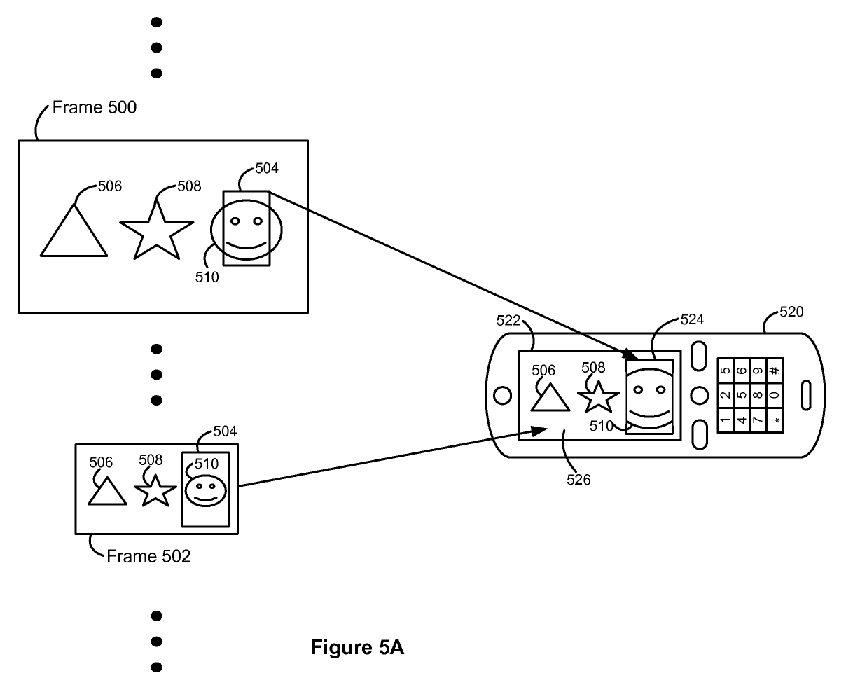

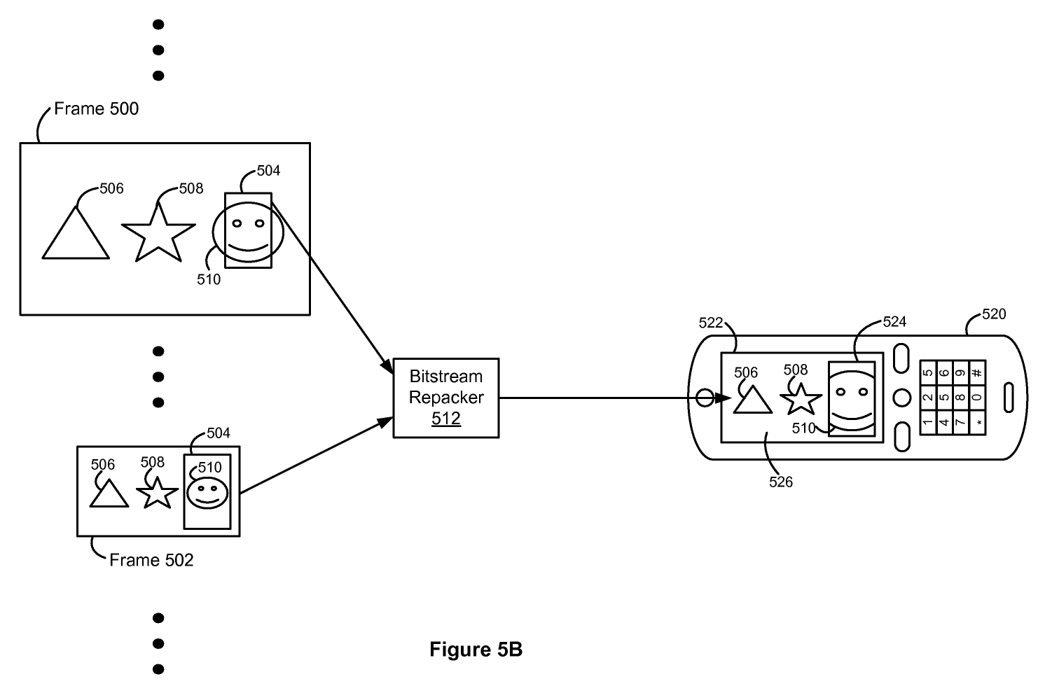

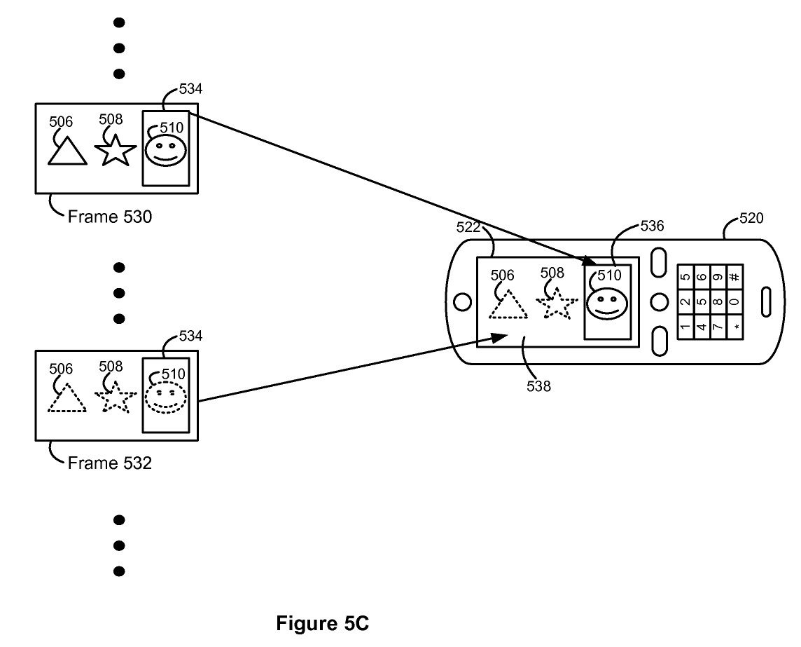

FIGS. 5A and 5B are prophetic, schematic diagrams of video frames and the user interface of a client device 520, illustrating display of a first region of video at a first video resolution level and a second region of video at a second video resolution level in accordance with some embodiments. Frames 500 and 502 are copies of a particular frame in a sequence of frames; frame 500 has a first video resolution level and frame 502 has a distinct second video resolution level. In the example of FIG. 5A, the video resolution of the frame 500 is higher than the video resolution level of the frame 502. In some embodiments, frames 500 and 502 are distinct levels of a particular multi-level frame (e.g., a MLVF 402, FIG. 4) in a sequence of multi-level frames (e.g., sequence 400, FIG. 4).

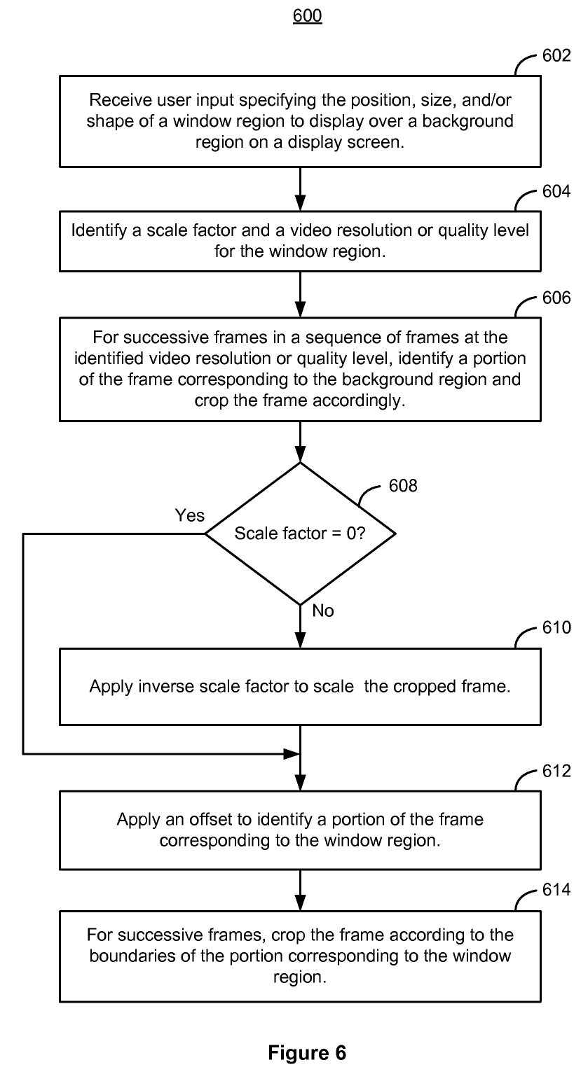

A video is displayed on a display screen 522 of a device 520 at a resolution corresponding to the video resolution level of the frame 502. In response to a user request to magnify a region within the displayed video, a portion 504 of the frame 500 is identified. The frame 500 itself is selected based on its video resolution level; examples of criteria for selecting a video resolution level are described below with regard to the process 600 (FIG. 6). A bitstream corresponding to the portion 504 of the frame 500 is extracted and provided to the device 520, which decodes the bitstream and displays the decoded video data in a window region 524 on the screen 522. Simultaneously, a bitstream corresponding to the frame 502, but excluding the portion 504 as overlaid on the frame 502, is extracted and provided to the device 520, which decodes the bitstream and displays the decoded video data in a background region 526 on the screen 522. As a result, objects (e.g., 506 and 508) in the background region 526 are displayed at a first video resolution and objects (e.g., 510) in the window region 524 are displayed at a second video resolution. The extraction, decoding, and display operations are repeated for successive frames in the video.

In some embodiments, the frames 500 and 502 are stored at a server system (e.g., in the video database 318 of the server system 300). The server system extracts bitstreams from the frames 500, 502 and transmits the extracted bitstreams to the client device 520, which decodes the received bitstreams. In some embodiments, the client device 520 includes multiple decoders: a first decoder decodes the bitstream corresponding to the portion 504 of the frame 500 and a second decoder decodes the bitstream corresponding to the frame 502. Alternatively, in some embodiments a single multi-level decoder decodes both bitstreams.

In some embodiments, a bitstream repacker 512 receives the bitstreams extracted from the frames 500 and 502 and repackages the extracted bitstreams into a single bitstream for transmission to the client device 520, as illustrated in FIG. 5B in accordance with some embodiments. In some embodiments, the single bitstream produced by the repacker 512 has standard syntax compatible with a standard decoder in the client device 520. For example, the single bitstream may have syntax compatible with a M-JPEG, MPEG-2, MPEG-4, H.263, H.264/AVC, or any other official or defacto standard video decoder in the client device 520.

In some embodiments, the frames 500 and 502 are stored in a memory in or coupled to the device 520, and the device 520 performs the extraction as well as the decoding and display operations.

FIG. 5C is a prophetic, schematic diagram of video frames and the user interface of a client device 520, illustrating display of a first region of video at a first video quality level and a second region of video at a second video quality level in accordance with some embodiments. Frames 530 and 532 are copies of a particular frame in a sequence of frames; frame 530 has a first video quality level and frame 532 has a distinct second video quality level. In the example of FIG. 5C, the video quality of the frame 530 is higher than the video quality level of the frame 532, as illustrated by the use of solid lines for the objects 506, 508 and 510 in the frame 530 and dashed lines for the objects 506, 508 and 510 in the frame 532. In some embodiments, frames 530 and 532 are distinct levels of a particular multi-level frame (e.g., a MLVF 402, FIG. 4) in a sequence of multi-level frames (e.g., sequence 400, FIG. 4).

A video is displayed on a display screen 522 of a device 520 at a quality corresponding to the video quality level of the frame 532. In response to a user request to view a region within the displayed video at an increased quality level, a portion 534 of the frame 530 is identified. The frame 530 itself is selected based on its video quality level; examples of criteria for selecting a video quality level are described below with regard to the process 600 (FIG. 6). A bitstream corresponding to the portion 534 of the frame 530 is extracted and provided to the device 520, which decodes the bitstream and displays the decoded video data in a window region 536 on the screen 522. Simultaneously, a bitstream corresponding to the frame 532, but excluding the portion 534, is extracted and provided to the device 520, which decodes the bitstream and displays the decoded video data in a background region 538 on the screen 522. As a result, objects (e.g., 506 and 508) in the background region are displayed at a first video quality and objects (e.g., 510) in the window region 524 are displayed at a second video quality. The extraction, decoding, and display operations are repeated for successive frames in the video.

In some embodiments, the frames 530 and 532 are stored at a server system that extracts the bitstreams and transmits the extracted bitstreams to the client device 520, as described above with regard to FIGS. 5A-5B. The client device 520 may decode the received bitstreams using multiple decoders or a single multi-level decoder. In some embodiments, a bitstream repacker repackages the extracted bitstreams into a single bitstream for transmission to the client device 520. In some embodiments, the single bitstream produced by the repacker has standard syntax compatible with a standard decoder in the client device 520. For example, the single bitstream may have syntax compatible with a M-JPEG, MPEG-2, MPEG-4, H.263, H.264/AVC, or any other official or defacto standard video decoder in the client device 520. In some embodiments, the frames 530 and 532 are stored in a memory in or coupled to the device 520, which performs the extraction as well as the decoding and display operations.

FIG. 6 is a flow diagram illustrating a method 600 of identifying a portion of a frame for display in a window region of a display screen in accordance with some embodiments. For example, the method 600 may be used to identify the portion 504 of frame 500 (FIGS. 5A and 5B) or the portion 534 of frame 530 (FIG. 5C). In the method 600, a display device (e.g., client device 520) receives (602) user input specifying the position, size, and/or shape of a window region (e.g., 524, FIGS. 5A-5B; 536, FIG. 5C) to display over a background region (e.g., 526, FIGS. 5A-5B; 538, FIG. 5C) on a display screen. For example, the user input for specifying the window region may be a user-controller pointer that is used to draw, position, or size a window region. The user-controller pointer may be a stylus or finger that touches a touch screen, or a mouse, trackball, touch pad or any other appropriate user-controller pointing mechanism.

A scale factor and a video resolution or quality level is identified (604) for the window region. In some embodiments, the scale factor specifies the degree to which video to be displayed in the window region is zoomed in or out with respect to the video displayed in the background region. In some embodiments, the video resolution level or video quality level is the highest resolution or quality level at which video may be displayed in the window region. In some embodiments, the video resolution level or video quality level is determined by applying the scale factor to the video resolution level or video quality level of the background region. In some embodiments, the video resolution level or video quality level is the highest resolution or quality level that may be accommodated by available bandwidth (e.g., transmission bandwidth from a server to a client device, or processing bandwidth at a display device).

For successive frames in a sequence of frames at the identified video resolution or quality levels, a portion of the frame corresponding to the background region is identified (606) and the frame is cropped accordingly. In some embodiments, cropping the frame includes selecting the tiles and/or macro-blocks that at least partially cover the background region. In some embodiments, the background region is constrained to have borders that coincide with the borders of tiles or macro-blocks, and cropping the frame includes selecting the tiles and/or macro-blocks that correspond to the background region.

If the scale factor is not equal to zero (608-No), an inverse scale factor is applied (610) to scale the cropped frame. For example, if the scale factor is 2×, such that both horizontal and vertical dimensions within the window region are to be expanded by a factor of two with respect to horizontal and vertical dimensions within the background region, then an inverse scale factor of 0.5 is applied to the cropped frame to define an area having a width and height equal to half the width and height, respectively, of the cropped frame. If the scale factor is equal to zero (608-Yes), operation 610 is omitted.

An offset is applied (612) to identify a portion of the frame corresponding to the window region. In some embodiments, the offset specifies a location within the frame of the portion of the frame corresponding to the window region, where the size of the portion corresponding to the window region is defined by the inverse scale factor.

For successive frames, each frame is cropped (614) according to the boundaries of the portion corresponding to the window region as identified in operation 612. In some embodiments, cropping the frame includes selecting the tiles and/or macro-blocks that at least partially cover the portion corresponding to the window region. In some embodiments, the portion corresponding to the window region is constrained to have borders that coincide with the borders of tiles or macro-blocks, and cropping the frame includes selecting the tiles and/or macro-blocks that correspond to the portion corresponding to the window region. The bitstream of the cropped frame then may be extracted and provided for decoding by the display device.

In some embodiments, a method analogous to the method 600 is used to determine a portion of a frame for display in a background region of a display screen, wherein the background region is scaled with respect to a previously displayed background region.

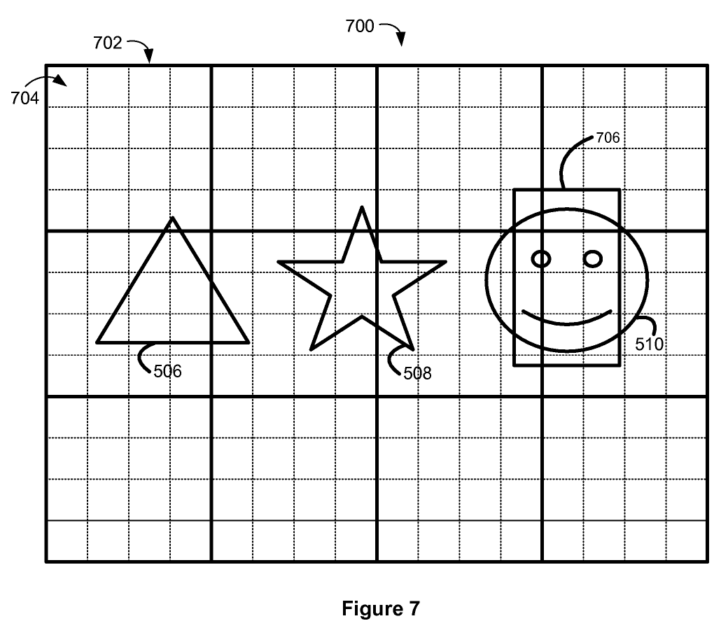

FIG. 7 is a prophetic, schematic diagram of a video frame 700 partitioned into tiles 702 (represented by solid line borders) and macro-blocks 704 (represented by dotted line borders) in accordance with some embodiments. In some embodiments, the frame 700 is a distinct level of a particular multi-level frame (e.g., a MLVF 402, FIG. 4) in a sequence of multi-level frames (e.g., sequence 400, FIG. 4). A portion 706 of the frame is identified for display in a window region on a display screen. In some embodiments, the portion 706 is identified according to the method 600 (FIG. 6).

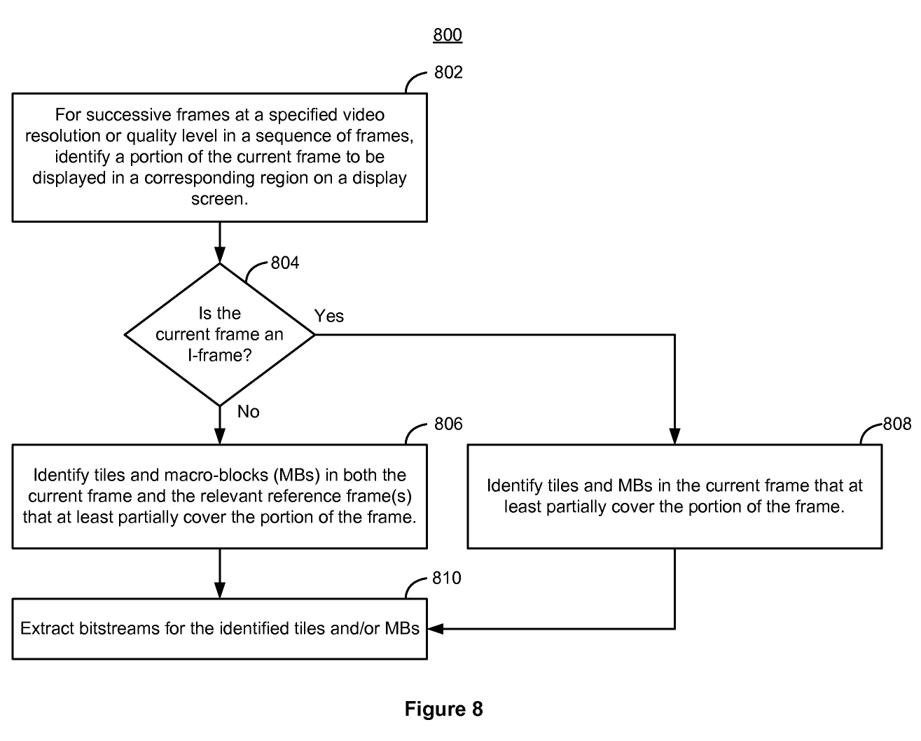

FIG. 8 is a flow diagram illustrating a method 800 for extracting bitstreams from frames, such as a frame 700 (FIG. 7), in accordance with some embodiments. For successive frames at a specified video resolution or video quality level in a sequence of frames, a portion of the frame to be displayed in a corresponding region on a display screen is identified (802). In some embodiments, the successive frames are frames at a particular level in successive MLVFs 402 (FIG. 4). In some embodiments, the corresponding region is a window region (e.g., 524, FIGS. 5A-5B; 536, FIG. 5C) and the portion is identified, for example, according to the method 600 (FIG. 6). In some embodiments, the corresponding region is a background region (e.g., 526, FIGS. 5A-5B; 538, FIG. 5C) that excludes a window region.

If the frame is an I-frame (804-Yes), tiles and macro-blocks in the current frame are identified (808) that at least partially cover the identified portion of the frame. If the frame is not an I-frame (804-No) (e.g., the frame uses predictive encoding), tiles and macro-blocks in the current frame and the relevant reference frame or frames are identified (806) that at least partially cover the identified portion of the frame.

The bitstreams for the identified tiles and/or MBs are extracted (810). The extracted bitstreams are provided to a decoder, which decodes the bitstreams for display in a corresponding region on a display screen.

In some embodiments, macro-blocks may be dual-encoded with and without predictive encoding. For example, if predictive encoding of a respective macro-block requires data outside of the macro-block's tile, then two versions of the macro-block are encoded: one using predictive encoding (i.e., “inter-MB coding”) and one not using predictive encoding (i.e., “intra-MB coding”). In some embodiments of the method 800, if a macro-block identified in operation 806 requires reference frame data from outside of the tiles identified in operation 806 as at least partially covering the portion, then the intra-MB-coded version of the macro-block is extracted. If the macro-block does not require reference frame data from outside of the identified tiles, then the inter-MB-coded version of the macro-block is extracted.

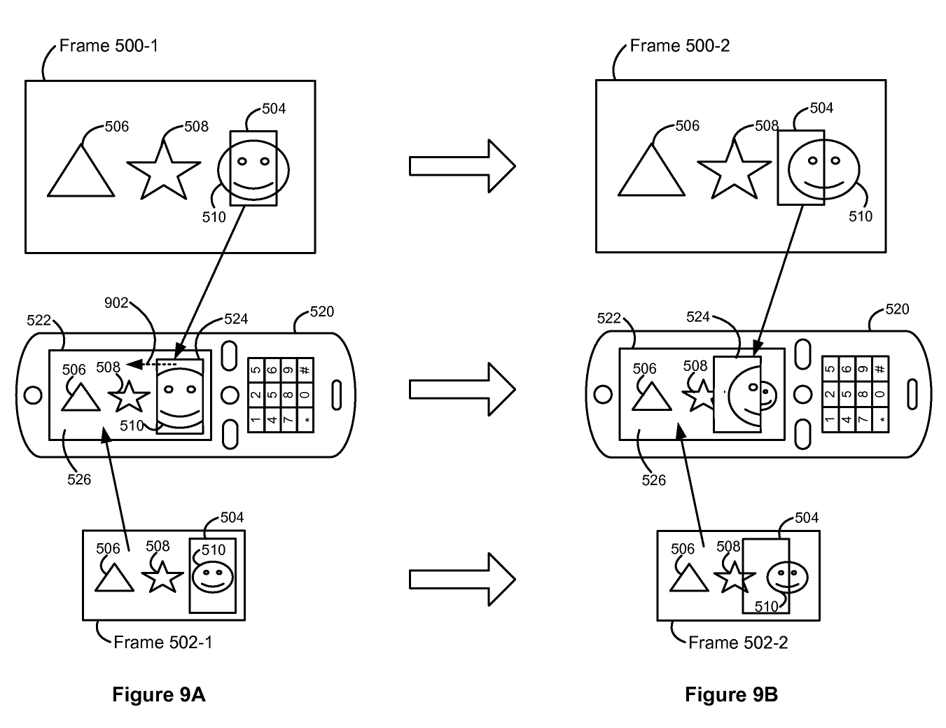

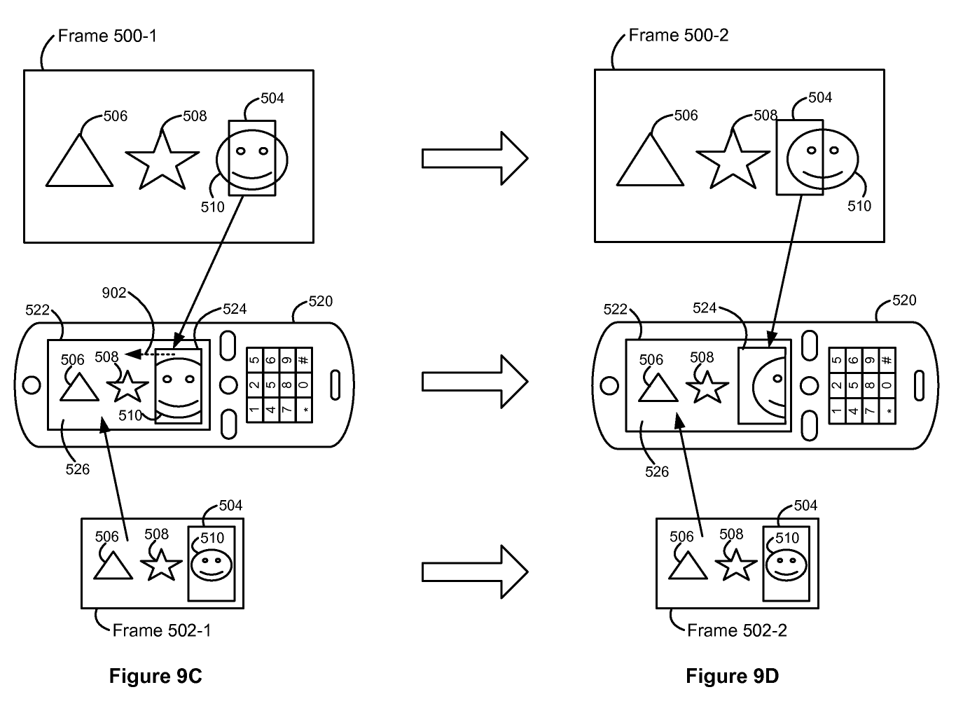

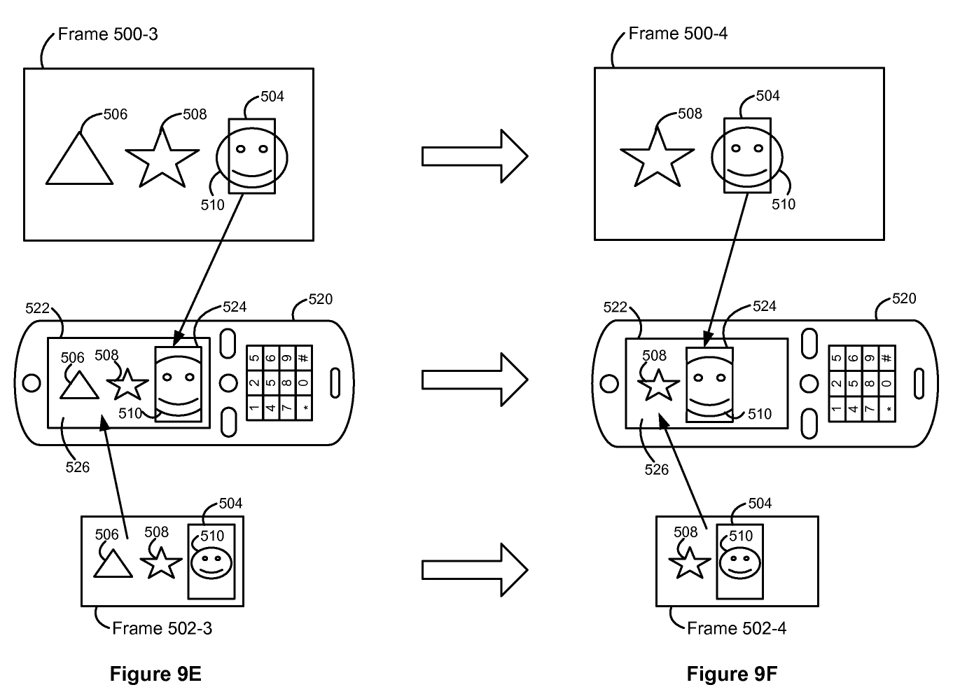

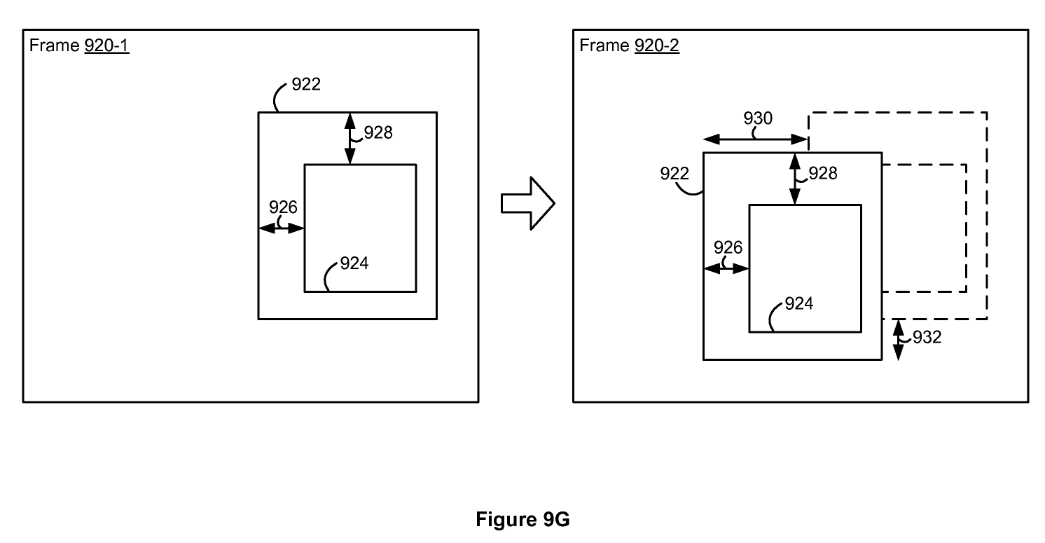

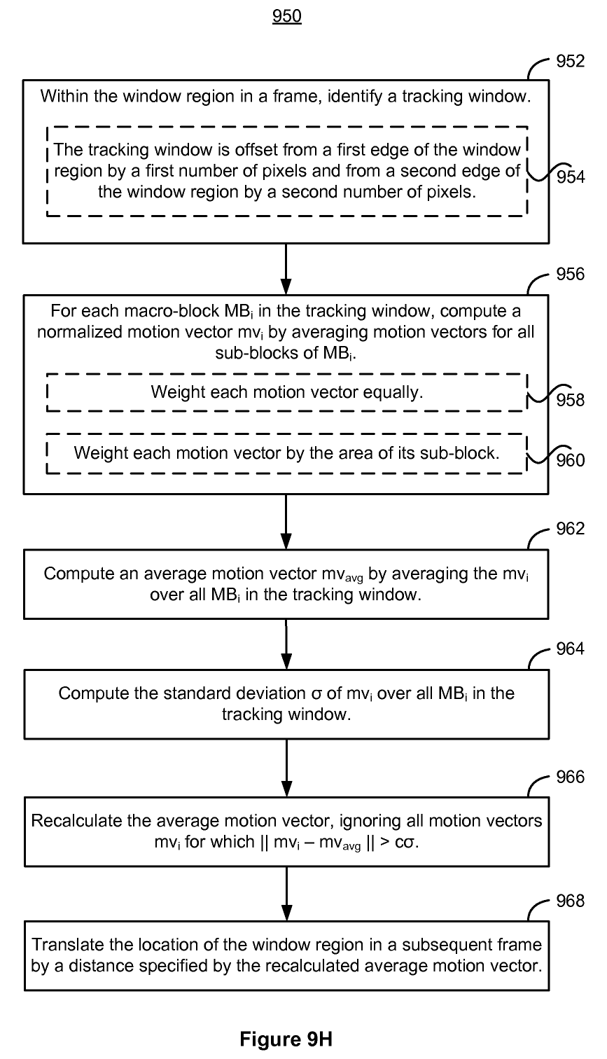

In some embodiments, a region on a display screen may be translated in response to user input. FIGS. 9A-9D, which are prophetic, schematic diagrams of video frames and the user interface of a client device 520, illustrate translation of a window region 524 on a display screen 522 in accordance with some embodiments. In FIGS. 9A and 9C, the window region 524 is displayed at a video resolution level corresponding to the video resolution level of a frame 500-1 and the background region 526 is displayed at a video resolution level corresponding to the video resolution level of a frame 502-1. As discussed above with regard to FIGS. 5A-5B, frames 500-1 and 502-1 are copies of a particular frame, with each copy having a distinct video resolution level.

User input 902 (FIGS. 9A and 9C) is received corresponding to an instruction to translate the window region 524. Examples of user input 902 include gesturing on the screen 522 with a stylus or finger, clicking and dragging with a mouse, or pressing a directional button on the device 520 or on a remote control. In some embodiments, the user input 902 is a continuation of an action taken to initiate display of the window region 524. For example, a user may tap the screen 522 with a stylus or finger to initiate display of the window region 524, and then move the stylus or finger without breaking contact with the screen 522 to translate the window region 524. Similarly, the user may click a button on a mouse or other pointing device to initiate display of the window region 524, and then move the mouse while still holding down the button to translate the window region 524. In some embodiments, user input that is not a continuation of an action taken to initiate display of the window region may correspond to a command to cease display of the current window region and to initiate display of a new window region in a new location on the screen 522.

In response to the user input 902, the location of the portion 504 to be displayed in the window region 524 is shifted in a subsequent frame 500-2 (FIG. 9B or 9D). In these examples, frame 500-1 precedes the user input 902 and frame 500-2 follows the user input 902. In some embodiments, as illustrated in FIG. 9B, the display location of the window region 524 on the screen 522 also is translated in response to the user input 902. In other embodiments, as illustrated in FIG. 9D, the display location of the window region 524 on the screen 522 remains fixed. (For visual clarity, the objects 506, 508, and 510 are shown at the same location in frames 500-2 and 502-2 as they are in frames 500-1 and 502-1; in general, of course, the location of objects in successive frames of a video may change.)

In some embodiments, the window region 524 is automatically translated, as illustrated in FIGS. 9E-9F in accordance with some embodiments. FIGS. 9E-9F are prophetic, schematic diagrams of video frames and the user interface of a client device 520. Frame 500-3 (FIG. 9E) precedes frame 500-4 (FIG. 9F) in a sequence of frames; in some embodiments, frames 500-3 and 500-4 are successive frames in the sequence. The location of objects in the frame 500-4 has changed with respect to the frame 500-3, corresponding to motion in the video. In this example, object 506 has moved out of the frames 500-4 and 502-4, and objects 508 and 510 have moved to the left. The window region 524 and the portion 504 to be displayed in the window region 524 are automatically translated in accordance with the motion of the object 510. Thus, in some embodiments, automatic translation allows a display window to continue to display an object or set of objects at a heightened video resolution when the object or set of objects moves.

In some embodiments, the location of the portion 504 in a frame 502 specifies a portion of the frame 502 to be excluded when extracting a bitstream to be decoded and displayed in the background region 526. For example, tiles or bitstreams that fall entirely within the portion 504 of a frame 502 are not extracted. In some embodiments in which the display location of the window region 524 on the screen 522 is translated in response to the user input 902, the location of the portion 504 is shifted in the frame 502-2 with respect to the frame 502-1, as illustrated in FIG. 9B. In some embodiments in which the display location of the window region 524 on the screen 522 is not translated in response to the user input 902, the location of the portion 504 is not shifted in the frame 502-2 with respect to the frame 502-1, as illustrated in FIG. 9D.

In some embodiments, a window region having a different (e.g., higher) video quality level than a background region may be translated, by analogy to FIGS. 9A-9B, 9C-9D, or 9E-9F.

FIG. 9H is a flow diagram illustrating a method 950 of implementing automatic translation of a window region in accordance with some embodiments. The method 950 is described with reference to FIG. 9G, which illustrates two frames 920-1 and 920-2 in a sequence of frames in accordance with some embodiments. In some embodiments, the frames 920-1 and 920-2 are successive frames in the sequence, with the frame 920-1 coming before the frame 920-2. In some embodiments, the frames 920-1 and 920-2 correspond to a distinct level in respective MLVFs.

In the method 950, a tracking window 924 is identified (952) within a window region 922 in the frame 920-1. In some embodiments, the tracking window 924 is offset (954) from a first edge of the window region 922 by a first number of pixels 926 and from a second edge of the window region 922 by a second number of pixels 928. In some embodiments, the offsets 926 and 928 are chosen substantially to center the tracking window 924 within the window region 922. In some embodiments the offsets 926 and 928 are adjustable to allow the location of the tracking window 926 to correspond to the location of a potential object of interest identified within the window region 922.

For each macro-block MBᵢ in the tracking window 924, a normalized motion vector mvᵢ is computed (956) by averaging motion vectors for all sub-blocks of MBᵢ, where i is an integer that indexes respective macro-blocks In some embodiments, each motion vector is weighted equally (958) when averaging the motion vectors (e.g., for MPEG-2 and baseline MPEG-4). Alternatively, in some embodiments a weighted average of the motion vectors for all sub-blocks of MBᵢ is calculated. For example, each motion vector is weighted by the area of its sub-block (960) (e.g., for H.264). In yet another example, the motion vectors of any non-moving sub-blocks is either excluded or given reduced weight (e.g., by a predefined multiplicative factor, such as 0.5) when computing the normalized motion vector for a respective macro-block.

An average motion vector mv_{avg} is computed (962) by averaging the mvᵢ over all MBᵢ in the tracking window 924. The standard deviation (σ) is computed of the mvᵢ over all MBᵢ in the tracking window. The average motion vector is then recalculated (966), ignoring (i.e., excluding from the calculation) all motion vectors mvᵢ for which ∥mvᵢ-mv_{avg}∥>cσ. In some embodiments, c is an adjustable parameter. In some embodiments, c equals 1, or 3, or is in a range between 0.5 and 10. Alternately, or from a conceptual point of view, the recomputed average motion vector is an average of motion vectors mvᵢ that excludes (from the computed average) non-moving macro-blocks and macro-blocks whose movement magnitude and/or direction is significantly divergent from the dominant movement (if any) within the tracking window.

The location of the window region is translated (968) in a subsequent frame by a distance specified by the recalculated average motion vector of operation 966. For example, the location of window region 922 in the frame 920-2 has been translated with respect to its location in the frame 920-1 by a horizontal distance 930 and a vertical distance 932, where the distances 930 and 932 are specified by the recalculated average motion vector of operation 966.

While the method 950 includes a number of operations that appear to occur in a specific order, it should be apparent that the method 950 can include more or fewer operations, which can be executed serially or in parallel (e.g., using parallel processors or a multi-threading environment), an order of two or more operations may be changed and/or two or more operations may be combined into a single operation. For example, operation 952 may be omitted and the remaining operations may be performed for the entire window region 922 instead of for the tracking window 924. However, use of a tracking window 924 saves computational cost and avoids unnecessary latency associated with the method 950.

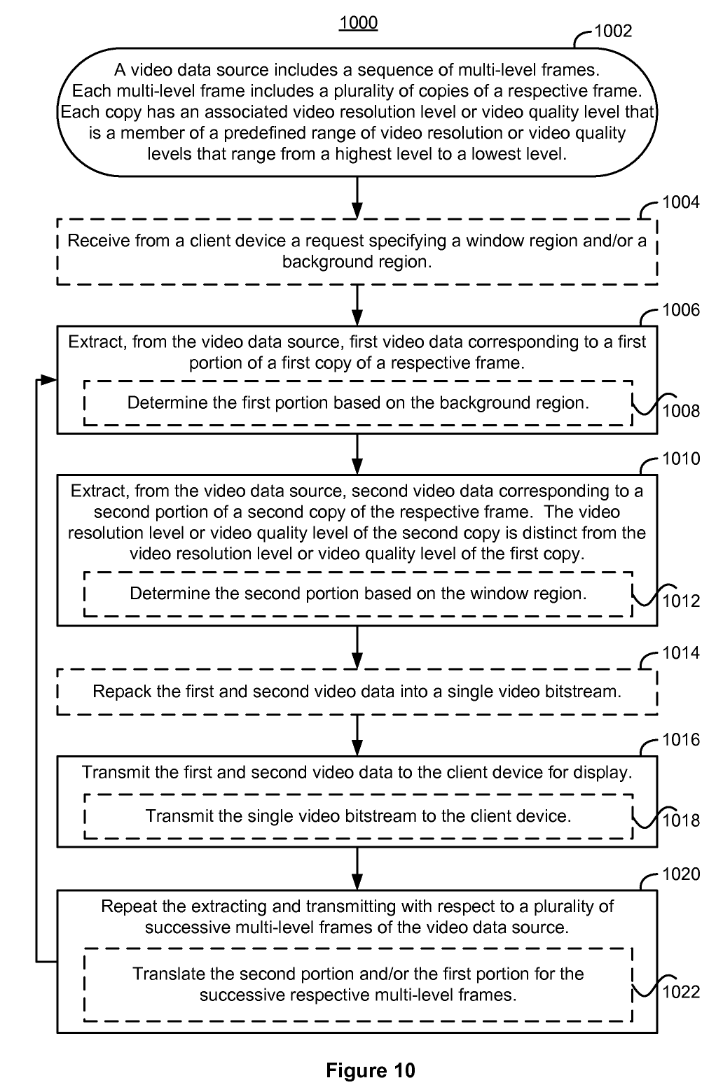

FIG. 10 is a flow diagram illustrating a method 1000 of providing video in accordance with some embodiments. The video is provided from a video data source (e.g., video database 110, FIG. 1) that includes (1002) a sequence of multi-level frames (e.g., a sequence 400 of MLVFs 402, FIG. 4). Each multi-level frame includes a plurality of copies of a respective frame. Each copy has an associated video resolution level or video quality level that is a member of a predefined range of video resolution or video quality levels that range from a highest level to a lowest level. In some embodiments, each multi-level frame is partitioned, for each copy in the plurality of copies, into a plurality of tiles (e.g., tiles 702, FIG. 7).

In some embodiments, a request is received (1004) from a client device (e.g., 520, FIGS. 5A-5C). The request specifies a window region (e.g., 524, FIGS. 5A-5B; 536, FIG. 5C) and/or a background region (e.g., 526, FIGS. 5A-5B; 538, FIG. 5C). In some embodiments, the request specifies a scale factor for the window region. In some embodiments, the request specifies a scale factor for the background region.

First video data are extracted (1006) from the video data source. The first video data corresponds to a first portion of a first copy of a respective frame. Examples of a first portion of the first copy include the portion of frame 502 (FIGS. 5A-5B) or 532 (FIG. 5C) that excludes the portion 504 or 534.

In some embodiments the first portion is determined (1008) based on the background region specified in the request. In some embodiments, determining the first portion includes applying an inverse scale factor (e.g., the inverse of the scale factor specified for the background region in the request) and determining an offset within the frame when extracting the first video data from the first copy of the respective frame.

Second video data are extracted (1010) from the video data source. The second video data corresponds to a second portion of a second copy of a respective frame (e.g., portions 504 or 534 of frames 500 or 530, FIGS. 5A-5C). The video resolution level or video quality level of the second copy is distinct from the video resolution level or video quality level of the first copy, and may be either higher or lower than the video resolution level or video quality level of the first copy.

In some embodiments the second portion is determined (1012) based on the window region specified in the request. In some embodiments, determining the second portion includes applying an inverse scale factor (e.g., the inverse of the scale factor specified for the window region in the request) and determining an offset within the frame when extracting the second video data from the second copy of the respective frame, as described for the method 600 (FIG. 6).

In some embodiments, extracting the first and second video data includes identifying a first set of tiles covering the first portion of the first copy and a second set of tiles covering the second portion of the second copy. In some embodiments, a respective tile includes a plurality of macro-blocks, including a first macro-block that is dual-encoded as both an intra-coded bitstream, without predictive coding, and an inter-coded bitstream, with predictive coding. Extracting the first (or second) video data includes extracting the intra-coded bitstream when the first macro-block requires data from outside of the first (or second) portion and extracting the inter-coded bitstream when the first macro-block does not require data from outside the first (or second) portion.

The first and second video data are transmitted (1016) to the client device for display.

In some embodiments, the first and second video data are repacked (1014) into a single video bitstream, which is transmitted (1018) to the client device for display. Repacking is illustrated in FIG. 5B in accordance with some embodiments. In some embodiments the single video bitstream has standard syntax, such as syntax compatible with M-JPEG, MPEG-2, MPEG-4, H.263, H.264/AVC, or any other official or defacto standard video decoders.

The extracting and transmitting are repeated (1020) with respect to a plurality of successive multi-level frames of the video data source.

In some embodiments, the second portion and/or the first portion are translated (1022) for the successive respective multi-level frames. In some embodiments the second portion and/or the first portion are translated in response to a request received from the client device (e.g., as illustrated in FIGS. 9A-F). In some embodiments, the second portion and/or the first portion are automatically translated based on motion vectors within the corresponding portion or a subset of the corresponding portion. Examples of automatic translation are described for the second portion with regard to FIGS. 9E-9H; analogous automatic translation may be performed for the first portion.

The method 1000 thus provides an efficient method of providing video data for display at separate video resolutions or quality levels in window and background regions. For example, by enabling the provided high resolution or high quality video data to correspond to a particular display region, the method 1000 efficiently uses available transmission bandwidth.

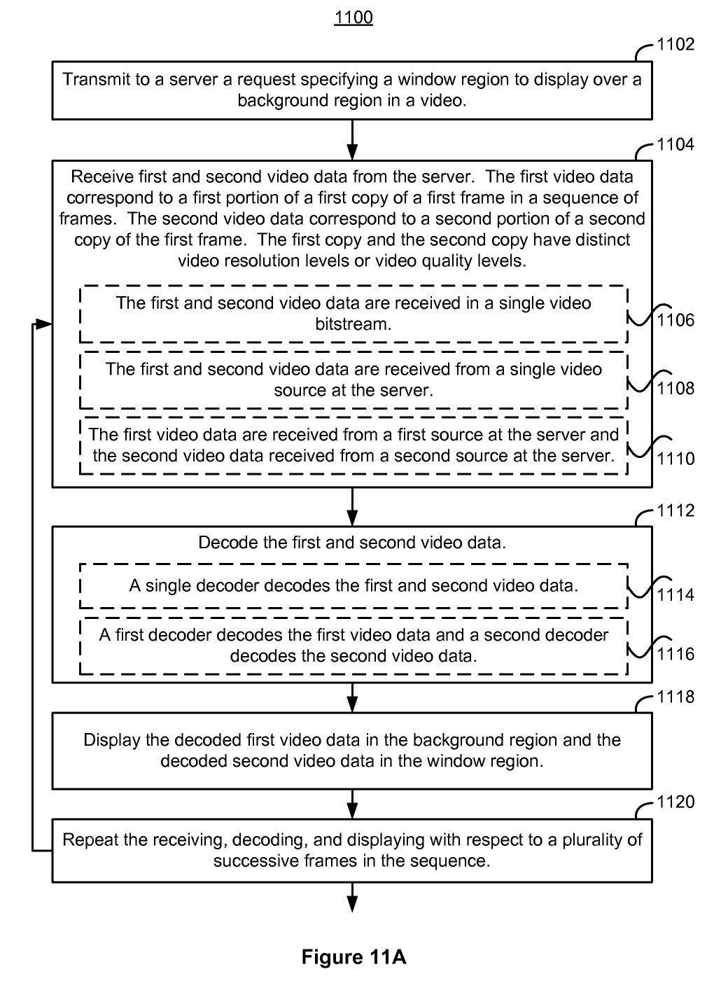

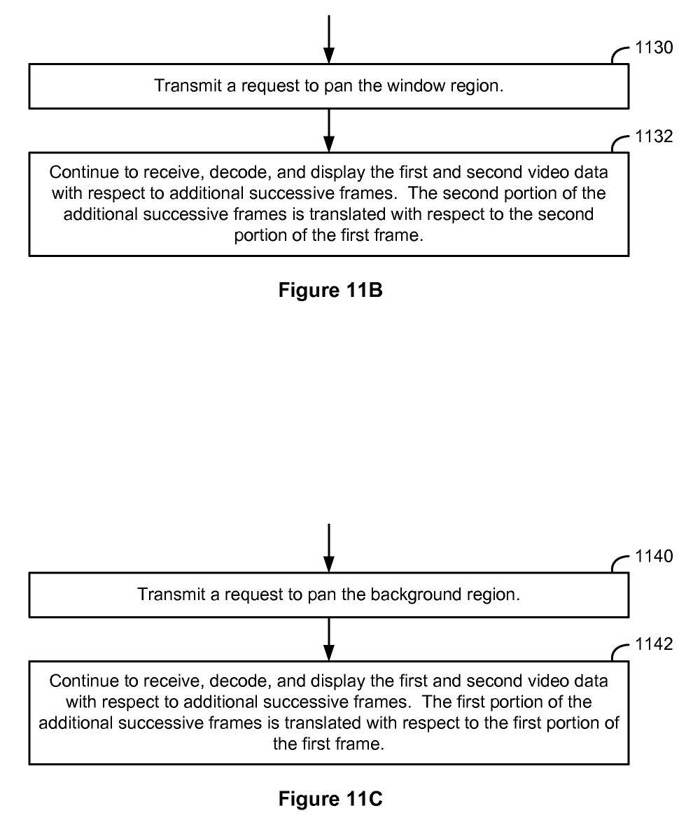

FIGS. 11A-11C are flow diagrams illustrating a method 1100 of displaying video at a client device (e.g., 102, FIG. 1) separate from a server (e.g., 104) in accordance with some embodiments. In the method 1100, a request specifying a window region (e.g., 524, FIGS. 5A-5B; 536, FIG. 5C) to display over a background region (e.g., 526, FIGS. 5A-5B; 538, FIG. 5C) in a video is transmitted (1102) to a server.

First and second video data are received (1104) from the server. The first video data correspond to a first portion of a first copy of a first frame in a sequence of frames. The second video data correspond to a second portion of a second copy of the first frame. The first copy and the second copy have distinct video resolution levels or video quality levels. Examples of a first portion of the first copy include the portion of frame 502 or 532 that excludes the portion 504 or 534 (FIGS. 5A-5C). Examples of a second portion of the second copy include portions 504 or 534 of frames 500 or 530 (FIGS. 5A-5C).

In some embodiments, the first and second video data are received (1106) in a single video bitstream, as illustrated in FIG. 5B. In some embodiments the single video bitstream has standard syntax, such as syntax compatible with M-JPEG, MPEG-2, MPEG-4, H.263, H.264/AVC, or any other official or defacto standard video decoders.

In some embodiments, the first and second video data are received (1108) from a single video source at the server (e.g., from a single MLVF 402, FIG. 4). In some embodiments, the first video data are received (1110) from a first source (e.g., a first file) at the server and the second video data are received from a second source (e.g., a second file) at the server.

The first and second video data are decoded (1112). In some embodiments, a single decoder decodes (1114) the first and second video data. In some embodiments, a first decoder decodes (1116) the first video data and a second decoder decodes the second video data.

In some embodiments, the first video data and/or the second video data include data extracted from an inter-coded bitstream of a first macro-block in the first frame and an intra-coded bitstream of a second macro-block in the first frame. In some embodiments, the first and second video data comprise a plurality of tiles in the first frame, wherein at least one of the tiles comprises a plurality of intra-coded macro-blocks and at least one of the tiles comprises a plurality of inter-coded macro-blocks.

The decoded first video data are displayed (1118) in the background region and the decoded second video data are displayed in the window region.

The receiving, decoding, and displaying are repeated (1120) with respect to a plurality of successive frames in the sequence.

In some embodiments, a request to pan the window region is transmitted (1130, FIG. 11B) to the server. In some embodiments, the request is generated in response to receiving user input to pan the window region (e.g., as illustrated in FIGS. 9A-9D). In some embodiments, the request is automatically generated based on motion vectors in the second portion or a subset of the second portion. Examples of automatic translation are described for the second portion with regard to FIGS. 9E-9H. Receiving, decoding, and display of the first and second video data are continued with respect to additional successive frames. The second portion of the additional successive frames is translated (1132) with respect to the second portion of the first frame, as illustrated in FIGS. 9A-9F.

In some embodiments, a request to pan the background region is transmitted (1140, FIG. 11C) to the server. In some embodiments, the request is generated in response to receiving user input to pan the background region. In some embodiments, the request is automatically generated based on motion vectors in the first portion or a subset of the first portion. Receiving, decoding, and display of the first and second video data are continued with respect to additional successive frames. The first portion of the additional successive frames is translated (1142) with respect to the first portion of the first frame.

The method 1100 thus provides a bandwidth-efficient method for displaying video at separate video resolutions or quality levels in window and background regions, by enabling the higher resolution or higher quality video data to correspond to a particular display region.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method of displaying video at a client device separate from a server, comprising:
transmitting to the server a request specifying a window region to display over a background region in a video;
receiving first and second video data from the server, the first video data corresponding to a first portion of a first copy of a first frame in a sequence of frames, the second video data corresponding to a second portion of a second copy of the first frame, wherein the first copy and the second copy have distinct video resolution levels;
decoding the first and second video data;
displaying the decoded first video data in the background region and the decoded second video data in the window region; and
repeating the receiving, decoding, and displaying with respect to a plurality of successive frames in the sequence.

2. The method of claim 1, wherein the first and second video data are received in a single video bitstream.

3. The method of claim 2, wherein the single video bitstream has syntax compatible with M-JPEG, MPEG-2, MPEG-4, H.263, or H.264 video decoders.

4. The method of claim 1, wherein the first video data are received from a first source at the server and the second video data are received from a second source at the server.

5. The method of claim 1, wherein the first and second video data are received from a single multiple-resolution video source at the server.

6. The method of claim 1, wherein a single decoder decodes the first and second video data.

7. The method of claim 1, wherein a first decoder decodes the first video data and a second decoder decodes the second video data.

8. The method of claim 1, wherein the request specifies a scale factor for the window region.

9. The method of claim 8, wherein the video resolution level of the second copy corresponds to the scale factor.

10. The method of claim 1, further comprising:
transmitting a request to pan the window region; and
continuing to receive, decode, and display the first and second video data with respect to additional successive frames, wherein the second portion of the additional successive frames is translated with respect to the second portion of the first frame.

11. The method of claim 10, further comprising:
receiving user input to pan the window region; and
in response to the user input, generating the request to pan the window region.

12. The method of claim 10, further comprising:
automatically generating the request based on motion vectors in the second portion or a subset thereof.

13. The method of claim 12, wherein the request specifies a shift in location of the window region corresponding to an average of motion vectors within the second portion or subset thereof.

14. The method of claim 13, wherein the average of motion vectors is a weighted average.

15. The method of claim 1, further comprising:
transmitting a request to pan the background region; and
continuing to receive, decode, and display the first and second video data with respect to additional successive frames, wherein the first portion of the additional successive frames is translated with respect to the first portion of the first frame.

16. The method of claim 1, wherein the first video data include data extracted from an inter-coded bitstream of a first macro-block in the first frame and an intra-coded bitstream of a second macro-block in the first frame.

17. The method of claim 1, wherein the first and second video data comprise a plurality of tiles in the first frame, wherein at least one of the tiles comprises a plurality of intra-coded macro-blocks and at least one of the tiles comprises a plurality of inter-coded macro-blocks.

18. A client device for displaying video, separate from a server, the client device comprising:
memory;
one or more processors;
one or more programs stored in the memory and configured for execution by the one or more processors, the one or more programs including:
instructions to transmit to the server a request specifying a window region to display over a background region in a video;
instructions to receive first and second video data from the server, the first video data corresponding to a first portion of a first copy of a first frame in a sequence of frames, the second video data corresponding to a second portion of a second copy of the first frame, wherein the first copy and the second copy have distinct video resolution levels;
instructions to decode the first and second video data;
instructions to display the decoded first video data in the background region and the decoded second video data in the window region; and
instructions to repeat the receiving, decoding, and displaying with respect to a plurality of successive frames in the sequence.

19. The client device of claim 18, wherein the client device is a set-top box, personal computer, or portable electronic device.

20. A computer readable storage medium storing one or more programs for use in displaying video at a client device separate from a server, the one or more programs configured to be executed by a computer system and comprising:
instructions to transmit to the server a request specifying a window region to display over a background region in a video;
instructions to receive first and second video data from the server, the first video data corresponding to a first portion of a first copy of a first frame in a sequence of frames, the second video data corresponding to a second portion of a second copy of the first frame, wherein the first copy and the second copy have distinct video resolution levels;
instructions to decode the first and second video data;
instructions to display the decoded first video data in the background region and the decoded second video data in the window region; and
instructions to repeat the receiving, decoding, and displaying with respect to a plurality of successive frames in the sequence.

21. A client device for displaying video, separate from a server, the client device comprising:
means for transmitting to the server a request specifying a window region to display over a background region in a video;
means for receiving first and second video data from the server, the first video data corresponding to a first portion of a first copy of a first frame in a sequence of frames, the second video data corresponding to a second portion of a second copy of the first frame, wherein the first copy and the second copy have distinct video resolution levels;
means for decoding the first and second video data; and
means for displaying the decoded first video data in the background region and the decoded second video data in the window region;
wherein the means for receiving, decoding, and displaying are configured to repeat the receiving, decoding, and displaying with respect to a plurality of successive frames in the sequence.

22. A method of displaying video at a client device separate from a server, comprising:
transmitting to the server a request specifying a window region to display over a background region in a video;
receiving first and second video data from the server, the first video data corresponding to a first portion of a first copy of a first frame in a sequence of frames, the second video data corresponding to a second portion of a second copy of the first frame, wherein the first copy and the second copy have distinct video quality levels;
decoding the first and second video data;
displaying the decoded first video data in the background region and the decoded second video data in the window region; and
repeating the receiving, decoding, and displaying with respect to a plurality of successive frames in the sequence.

23. A method of providing video from a video data source, the video data source comprising a sequence of multi-level frames, wherein each multi-level frame comprises a plurality of copies of a respective frame, each copy having an associated video resolution level, the video resolution level of each copy being a member of a predefined range of video resolution levels that range from a highest video resolution level to a lowest video resolution level, the method comprising:
extracting, from the video data source, first video data corresponding to a first portion of a first copy of a respective frame;
extracting, from the video data source, second video data corresponding to a second portion of a second copy of the respective frame, wherein the video resolution level of the second copy is distinct from the video resolution level of the first copy;
transmitting the first and second video data to a client device for display; and
repeating the extracting and transmitting with respect to a plurality of successive multi-level frames of the video data source.
